(19) United States
(12) Patent Application Publication
(10) Pub. No.: US 2005/0125790 A1
(43) Pub. Date: Jun. 9, 2005

(54) Device for accelerating the interpretation of a program written in an interpreted language

(75) Inventors: Selim Ben-Yedder, Gagny (FR); Ludvik Davidovic, Courquetaine (FR); Menno M. Lindwer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/506,831

(22) PCT Filed: Mar. 3, 2003
(86) PCT No.: PCT/IB03/00881

(30) Foreign Application Priority Data
Mar. 12, 2002 (FR) 02/03075

(51) Int. Cl. G06F 9/46

(52) U.S. Cl. 718/100

(57) ABSTRACT

The present invention relates to a device (10) for accelerating the interpretation of a program in interpreted language, said program comprising an intermediate code which can be executed by a virtual machine in the form of successive tasks, said device comprising routing means (13) able to extract a current intermediate code from a memory (11) in order to load it into storage means (16). When there is a request for a change of task, the routing means (13) are able to inhibit the extraction of the current intermediate code and to load into the storage means (16) a reserved intermediate code intended to effect a saving of a context of the virtual machine.

The present invention relates to a device for accelerating the interpretation of a program in interpreted language, said program comprising an intermediate code which can be executed by a virtual machine in the form of successive tasks, said device comprising routing means able to extract a current intermediate code from a memory in order to load it into storage means.

It finds in particular its application in portable programming languages, of the JAVA™ type for example, and more particularly in the interpretation and execution of such programming languages.

Such a device can be integrated in digital television receivers-decoders, also called set-top boxes, mobile telephones or any other apparatus able to execute programs written in a programming language of this type.

The JAVA™ language is a so-called interpreted programming language. Its main advantage is being entirely portable or multiplatform, a program written in such a language being able to be executed in an environment other than the one for which it was designed. One of the reasons for its success is its ability to be inserted in an html (“HyperText Markup Language”) page in the form of an executable application called applet by means of a virtual machine.

A program in JAVA™ language is able to generate an intermediate code also called bytecode between the source code and the executable binary code. The intermediate code is executed by means of a virtual machine. This intermediate code is therefore not directly comprehensible to the processor, which may cause a certain amount of slowness in the execution of the program.

Devices for accelerating the processing of virtual machines so as to interpret intermediate code more rapidly are known in the state of the art. The PCT patent application WO/9918484 describes such a device known as a virtual machine interpreter. A virtual machine interpreter is generally a preprocessor, placed between a memory containing intermediate code and a processor, which makes it possible to translate the intermediate code into a set of instructions which can be executed by the processor.

In such an environment, a change of task, from a present JAVA™ task to a new JAVA™ task, may occur at an arbitrary moment, and particularly during the translation of an intermediate code. Conventionally, the tasks are managed by an operating system and the operating system causes the processor to save its own state and the state of any hardware element concerned, such as that of the virtual machine interpreter in our case, during a change of task. This saving is effected using a save routine. Thus, during a change of tasks, a set of registers, representing the state of the virtual machine interpreter and the state of a processor at the time of change of task, is saved so as to be restored subsequently in order to represent the state of the new JAVA™ task.

However, the save routines for saving the states of hardware may take hundreds of clock cycles, that is to say tens of milliseconds, per change of task. Such an operation therefore has the drawback of being particularly slow.

The aim of the present invention is to propose a device for accelerating the interpretation of a program in interpreted language which is faster than the one of the state of the art during a change of task.

To this end, said device is characterized in that it comprises routing means which are able to inhibit the extraction of the current intermediate code and to load into the storage means a reserved intermediate code intended to effect a saving of a context of the virtual machine, during a task change request.

Thus the device for accelerating the interpretation of a program in interpreted language is able itself to provide a change of task, in place of the operating system. For this purpose, it uses a reserved object code which makes it possible to save only a context of the virtual machine, said context comprising certain parameters, such as a stack pointer for example, which will be useful during the processing of the next current intermediate code after the change of task.

Such a mechanism also makes it possible to process the intermediate codes continuously without interrupting the processing of a current intermediate code and therefore to make a change of task in a stable state of the operating system. Thus it is no longer necessary to save the registers of the device in order to accelerate the interpretation of the interpreted language and of the processor, unlike what was done in the state of the art.

The present invention also relates to an apparatus able to execute a program according to an interpreted language and comprising the device for accelerating the interpretation of the interpreted language.

The invention will be further described with reference to examples of embodiments shown in the drawings to which, however, the invention is not restricted.

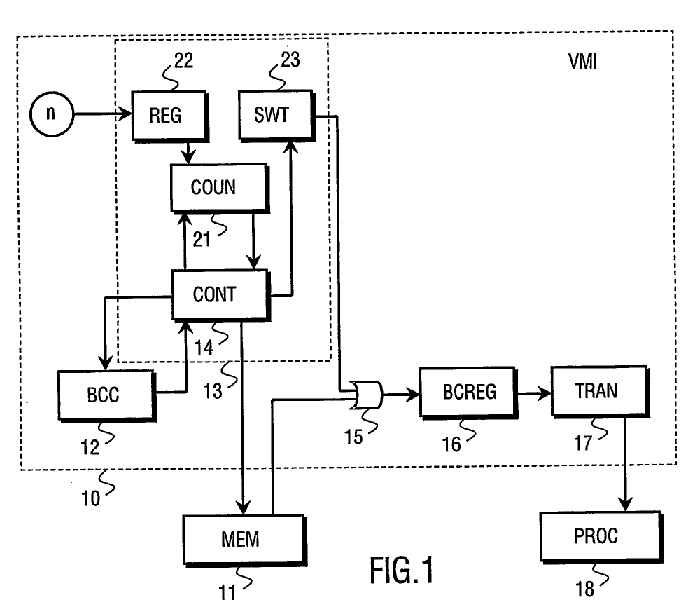

FIG. 1 depicts a first embodiment of the invention where a predetermined number of intermediate codes are executed between two changes of task, and

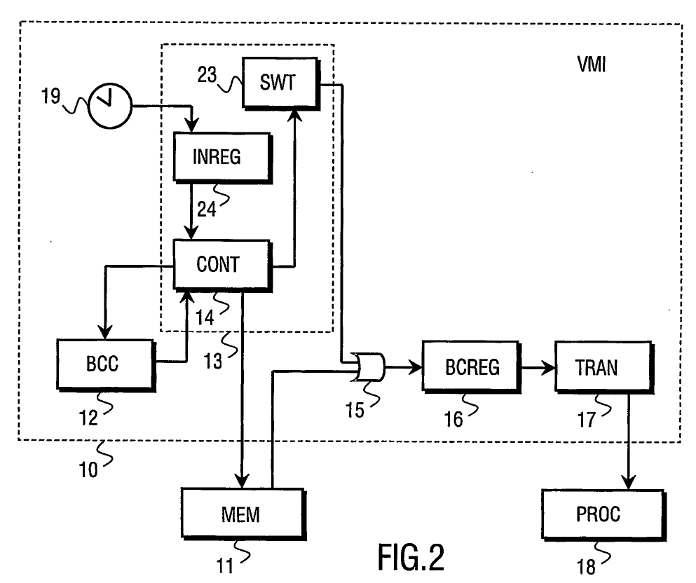

FIG. 2 depicts a second embodiment of the invention in which a predetermined time period elapses between two changes of task.

The present invention has been developed in the context of the design of a virtual machine interpreter for accelerating the interpretation of the JAVA™ language. It will however be clear to a person skilled in the art that it is applicable to other programming languages provided that they are able to generate an intermediate code between the source code and the executable binary code, said intermediate code having to be interpreted in order to be executed by a processor. It may be a case for example of the LISP language or the C# language of Windows XP.

An intermediate JAVA™ code comprises a mnemonic, corresponding for example to an instruction of the addition or subtraction type, and possibly one or more operands, corresponding to a constant-type argument for example. A mnemonic is coded in 8 bits and the 256 mnemonics thus enabled are not all used. There therefore remain certain intermediate codes which can be reserved by the JAVA™ virtual machine for internal usage. These reserved intermediate codes cannot subsequently be used for another usage. The present invention proposes to use one of these reserved intermediate codes in order to manage a change of JAVA™ tasks.

In addition, the virtual machine interpreter is able itself to provide a change of JAVA™ tasks, in place of the operating system. Thus, during a change of task, it is able to replace a current intermediate code with the reserved intermediate code. The execution of the reserved intermediate code generates a function call enabling a software for the time management of tasks, also called scheduler, to save a context of the virtual machine, corresponding generally to a set of parameters comprising a stack pointer, a global pointer, a program counter and a JAVA™ frame pointer. These parameters are then restored during the execution of the next current intermediate code.

Thus the latency time due to the change of task is reduced and allows execution of the intermediate code without interruption.

In a first embodiment illustrated in FIG. 1 the virtual machine interpreter VMI (10) makes it possible to map between a time slice and a time taken for executing a predetermined number n of current intermediate codes between two successive changes of task.

For this purpose, the virtual machine interpreter VMI (10) comprises a current intermediate code counter BCC (12) able to indicate to a control circuit CONT (14) an address of a memory MEM (11), said address corresponding to a current intermediate code to be extracted from said memory in order to load it into an intermediate code register BCREG (16). The virtual machine interpreter VMI (10) comprises routing means (13), said means comprising, in addition to the control circuit CONT (14), a routing counter COUN (21) whose predetermined initial value n, corresponding to the number of intermediate codes to be executed between two changes of task, is initially loaded via a register REG (22).

The control circuit CONT (14) increments the counter BCC (12) after a processing of a current intermediate code, in order to be able to point to the next current intermediate code. Each time a current intermediate code is routed from the memory MEM (11) to the register BCREG (16), the control circuit CONT (14) also decrements the routing counter COUN (21).

When the number of current intermediate codes routed is greater than the predetermined initial value n, i.e. the routing counter COUN (21) has the value zero, the counter BCC (12) is not incremented by the control circuit CONT (14), and a current intermediate code is replaced by a reserved intermediate code called “software trap bytecode”, extracted from a register SWT (23) by the control circuit CONT (14) in order to be loaded into the register BCREG (16). A gate (15) performing the “OR” function expresses the fact that the register BCREG (16) is able to receive either a current intermediate code in the general case or a reserved intermediate code during a change of task. This reserved intermediate code is able to generate a function call for saving and restoring a context of the virtual machine for the processing of the next current intermediate code.

The virtual machine interpreter also comprises a translation module TRAN (17) for the current intermediate codes functioning according to a principle known to persons skilled in the art and using in particular translation tables. The code issuing from the translation module TRAN (17) is then transmitted to a processor PROC (18), either in the form of executable code or in the form of reserved intermediate code able to generate the saving.

Thus the virtual machine interpreter VMI (10) according to the invention functions without interruption and a predetermined number of intermediate codes are executed between two successive changes of JAVA™ task.

In a second embodiment, illustrated in FIG. 2, the virtual machine interpreter VMI (10) is able to manage the execution of current intermediate codes within a time slice with a predetermined duration equal to a fixed duration to which there is added a lapse of time corresponding to the end of the execution of the last current intermediate code.

For this purpose, said interpreter comprises an interrupt register INREG (24) able to receive an interrupt of an external or internal clock (19). When an interrupt corresponding to a request for change of task is requested, the interrupt register INREG (24) is activated by the clock (9). When the next intermediate code is processed, the control circuit CONT (14) will then not increment the counter BCC (12) and a current intermediate code is replaced by a reserve intermediate code extracted from a register SWT (23) by the control circuit CONT (14). The register BCREG (16) thus receives the reserved intermediate code in place of a current intermediate code, this reserved intermediate code being able to generate a function call for saving a context of the virtual machine.

The virtual machine interpreter VMI (10) as described in the two embodiments can be incorporated in a programmable integrated circuit, for example a circuit of the FPGA (“Field Programmable Gate Array”) type.

Such a virtual machine interpreter can be integrated into video decoders, digital television receiver-decoders, television sets, mobile telephones, personal digital assistants or any other apparatus able to execute programs written in JAVA™ language or in any other interpreted language.

No reference sign between parentheses in the present text should be interpreted limitingly. The verb “comprise” and its conjugations should also be interpreted broadly, that is to say as not excluding the presence not only of elements or steps other than those listed after said verb but also a plurality of elements or steps already listed after said verb and preceded by the word “a” or “one”.

1. A device (10) for accelerating the interpretation of a program in interpreted language, said program comprising an intermediate code which can be executed by a virtual machine in the form of successive tasks, said device comprising routing means (13) able to extract a current intermediate code from a memory (11) in order to load it into storage means (16), characterized in that the routing means (13) are able to inhibit the extraction of the current intermediate code and to load into the storage means (16) a reserved intermediate code intended to effect a saving of a context of the virtual machine, during a request for a change of task.

2. A device (10) for accelerating the interpretation of a program in interpreted language as claimed in claim 1, characterized in that the routing means (13) comprise a routing counter (21) initialized to a predetermined value corresponding to the number of current intermediate codes to be processed between two successive changes of task and decremented whenever a current intermediate code is extracted from the memory (17), the reserved intermediate code being loaded into the storage means (16) when the routing counter (21) has the value zero.

3. A device (10) for accelerating the interpretation of a program in interpreted language as claimed in claim 1, characterized in that the routing means (13) comprise an interrupt register (24) able to be activated during a request for a change of task so that the reserved intermediate code is loaded into the storage means (16).

4. An apparatus able to execute programs according to an interpreted language and comprising a device as claimed in claim 1 for accelerating the interpretation of the interpreted language.
